(19) United States
(12) Patent Application Publication
(10) Pub. No.: US 2012/0127090 A1
(43) Pub. Date: May 24, 2012

(54) OPTICAL TOUCH MODULE AND OPTICAL TOUCH DISPLAY MODULE THEREWITH

(76) Inventors: Chi-Sheng Lin, Taoyuan County (TW); Hung-Yi Ou Yang, Taoyuan County (TW); Chen-Sing Huang, Taipei County (TW)

(21) Appl. No.: 13/009,863

(22) Filed: Jan. 20, 2011

(30) Foreign Application Priority Data
Nov. 18, 2010 (TW) 099222344

(51) Int. Cl. G06F 3/041

(52) U.S. Cl. 345/173

(57) ABSTRACT

An optical touch module and an optical touch display module therewith are disclosed. The optical touch module includes a frame, a transparent plate, and an optical sensing module. The frame includes a plurality of rims connected to form a hollow portion. The transparent plate is fixed on the frame to cover the hollow portion and has a touch indication area opposite to the hollow portion. The optical sensing module is disposed on the frame for sensing a touch operation on the touch indication area. When the frame is engaged with a frame of a display module, the transparent plate covers a display panel of the display module, and the optical touch display module according to the invention is therefore formed. Thereby, the invention solves problems of a poor stability of manufacturing and a poor product yield induced by only sticking components of an optical touch module onto a display module.

### BACKGROUND OF THE INVENTION

1. Field of the Invention

The invention relates to an optical touch module and an optical touch display module therewith and especially relates to an optical touch module having an independent frame capable of being engaged with a display module, and an optical touch display module therewith.

2. Description of the Prior Art

As the optical touch technology develops maturely, the price of products thereof is lower than that of conventional capacitive or resistive touch panel, so the products have been widely used in various touch display products. In the present day, an optical touch module is usually joined to an LCD display module. For preventing the LCD panel thereof from the damage due to any careless touch operation by a user, a transparent protection plate adheres over the LCD panel by an adhesion method, and then components of the optical touch module also adhere to the circumference of the transparent protection plate by a similar adhesion method.

Because the user requires the prompt by the LCD display module for touch operation, the relative position of the optical touch module and the LCD display module is significant. Obviously, the assembly by adhesion method cannot provide precisely-positioning function, and it is more difficult to control the above relative position. Although a procedure for adjusting touch operation is performed on the optical touch module after the assembly, any worse variation of production still cannot be overcome through the procedure. For example, fails in adherence of the optical sensors lead to not capturing images at required directions; oblique adherence of reflective sheets leads to larger judgment errors by a touch point analysis program, even to failure.

In addition, either in the reworking in the production or in the repair after a period of use, it is difficult to detach the adhered optical touch module from the display module. Although the optical touch module can be detached by heating, chemical solution, or mechanical impact, such detached optical touch module, even the display module, is damaged more or less. Therefore, there are problems of production and repair in the assembly of the optical touch module and the LCD display module, which leads to significant effects on the yield and quality of products.

Taiwan patent No. M372476 discloses a modular front frame with protection function used into a part of a casing of a display apparatus. The modular front frame includes a frame member and a transparent plate. The frame member has a hollow frame hole. The transparent plate is disposed inside the frame member; therein, the fringe of the transparent plate interferes with the inside of the frame member, and the transparent plate covers the frame hole, so as to form the modular front frame, also conducive to the assembly of the casing in the production line. However, it only simplifies the assembly of the transparent plate on the frame member for protection. It still cannot solve the above-mentioned problems of production and repair in the assembly of the optical touch module and the LCD display module.

### SUMMARY OF THE INVENTION

An objective of the invention is to provide an optical touch module, which includes an independent frame capable of being engaged with a display module so as to avoid the instability due to the adhesion process, to increase the reliability of product, and to improve the quality of the post-repair on the product.

An optical touch module according to the invention is used for being engaged with a display module which includes a first frame and a display panel. The optical touch module includes a second frame, a transparent plate, and an optical sensing module. The second frame is used for being engaged with the first frame. The second frame includes a plurality of rims connected to form a hollow portion. The transparent plate is fixed on the second frame to cover the hollow portion. The transparent plate has a touch indication area opposite to the hollow portion. The optical sensing module is disposed on the second frame for sensing a touch operation on the touch indication area. When the second frame is engaged with the first frame, the transparent plate covers the display panel.

Thereby, the optical touch module can be easily engaged with the display module, which is conducive to increasing the stability in production and the reliability of product. If a detachable lock engagement structure is further involved to be the engagement mechanism, the optical touch module also can be easily detached from the display module, which is conducive to the quality of the post-repair on the optical touch module. In addition, the transparent plate can achieve the purpose of efficiently protecting the display panel by way of the position effect due to the engagement of the second frame and the first frame.

Another objective of the invention is to provide an optical touch display module, which uses the optical touch module according to the invention so as to avoid the instability due to the adhesion process, to increase the reliability of product, and to improve the quality of the post-repair on the product.

An optical touch display module according to the invention includes a display module and an optical touch module. The display module includes a first frame and a display module disposed on the first frame. The optical touch module includes a second frame engaged with the first frame, a transparent plate, and an optical sensing module. The second frame includes a plurality of rims connected to form a hollow portion. The transparent plate is fixed on the second frame to cover the hollow portion and the display panel. The transparent plate has a touch indication area opposite to the hollow portion. The optical sensing module is disposed on the second frame for sensing a touch operation on the touch indication area. Thereby, the optical touch display module also has the advantages of the optical touch module according to the invention, which is no longer described more.

Therefore, the optical touch module according to the invention and the optical touch display module therewith utilize the engagement structure of independent frames so as to solve the problems in the prior art of worse variation of production, poor yield of product, and difficulty in repair, to provide a better fixing structure, and to increase the stability and reliability of product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an optical touch display module of a preferred embodiment according to the invention.

FIG. 2 is an exploded diagram of the optical touch display module in FIG. 1.

FIG. 3 is a partial exploded diagram of the optical touch module in FIG. 2.

FIG. 4 is a partial enlarged diagram of the optical touch module in FIG. 2.

FIG. 5 is another partial enlarged diagram of the optical touch module in FIG. 2.

### DETAILED DESCRIPTION

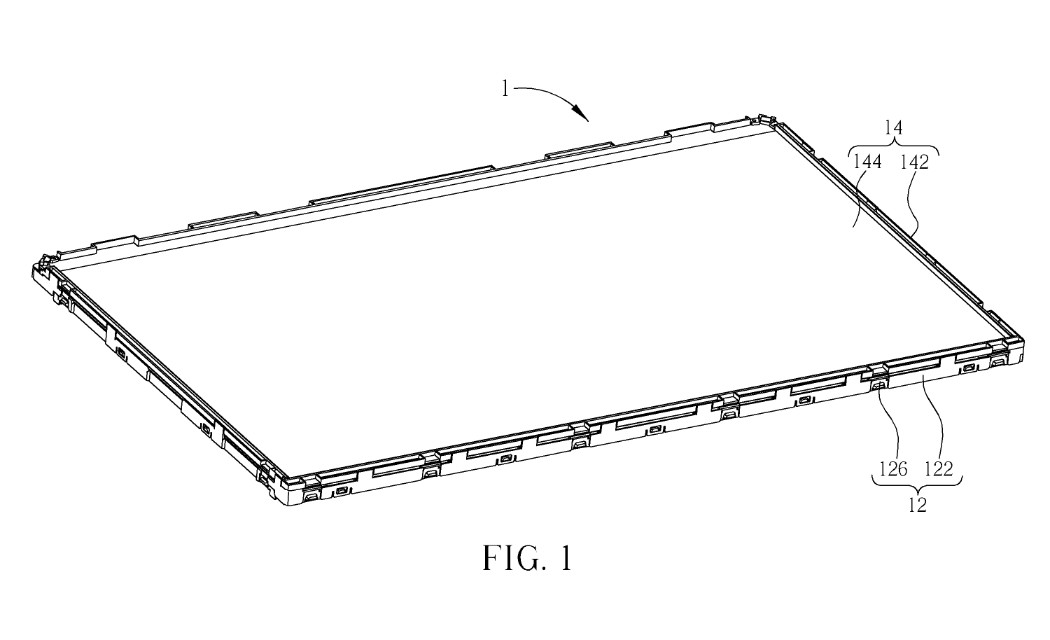

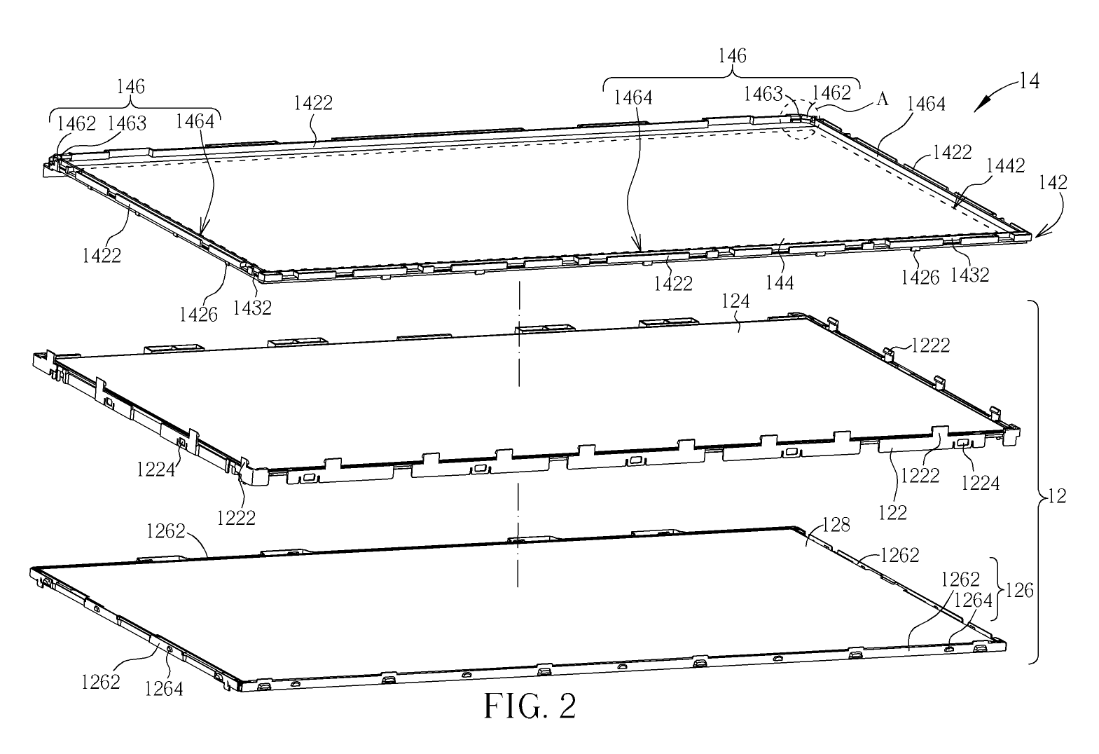

Please refer to FIG. 1 and FIG. 2. FIG. 1 is a schematic diagram of an optical touch display module 1 of a preferred embodiment according to the invention. FIG. 2 is an exploded diagram of the optical touch display module 1 in FIG. 1. The optical touch display module 1 includes a display module 12 and an optical touch module 14 engaged with the display module 12. The display module 12 includes a first frame 122, a display panel 124, a back plate 126, and a backlight module 128. The first frame 122 is substantially a rectangle frame. The display panel 124 is disposed on the first frame 122. The back plate 126 is formed substantially by a flat plate, the circumference of which is bended to be sidewalls 1262 to form a shallow dish structure where the backlight module 128 is disposed. The back plate 126 is engaged with the first frame 122 by the sidewalls 1262 thereof. Therein, the back plate 126 and the first frame 122 are engaged to form an accommodating space (not indicated in the figures) for accommodating the display panel 124, the backlight module 128, and other related components.

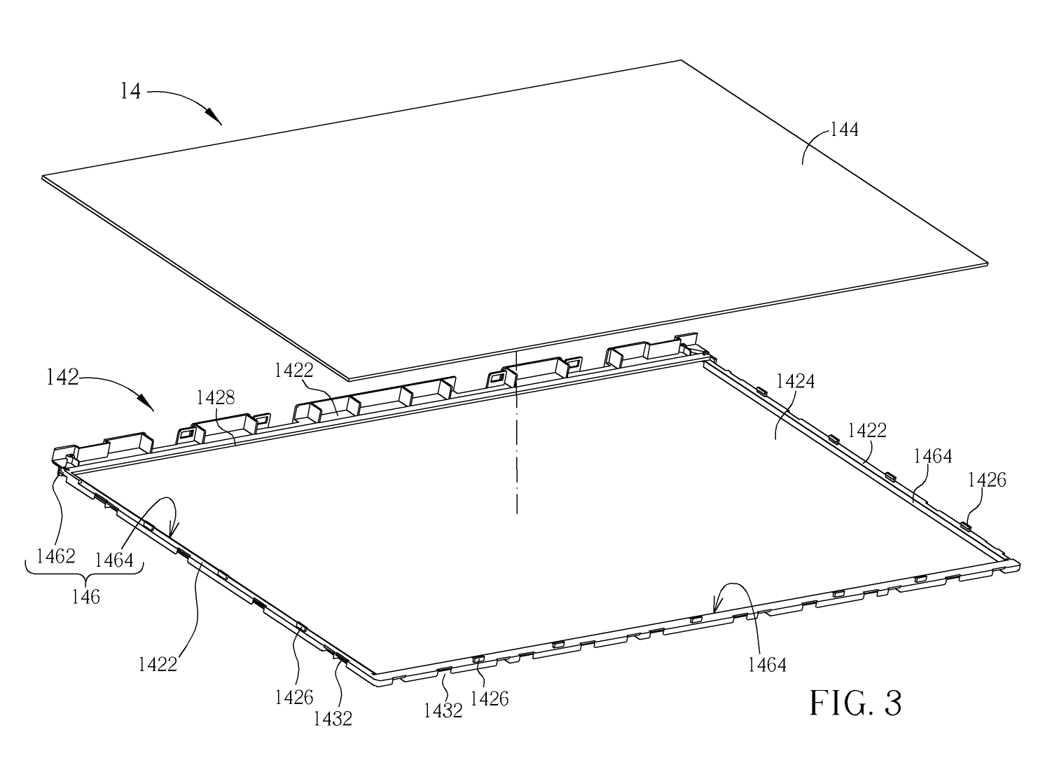

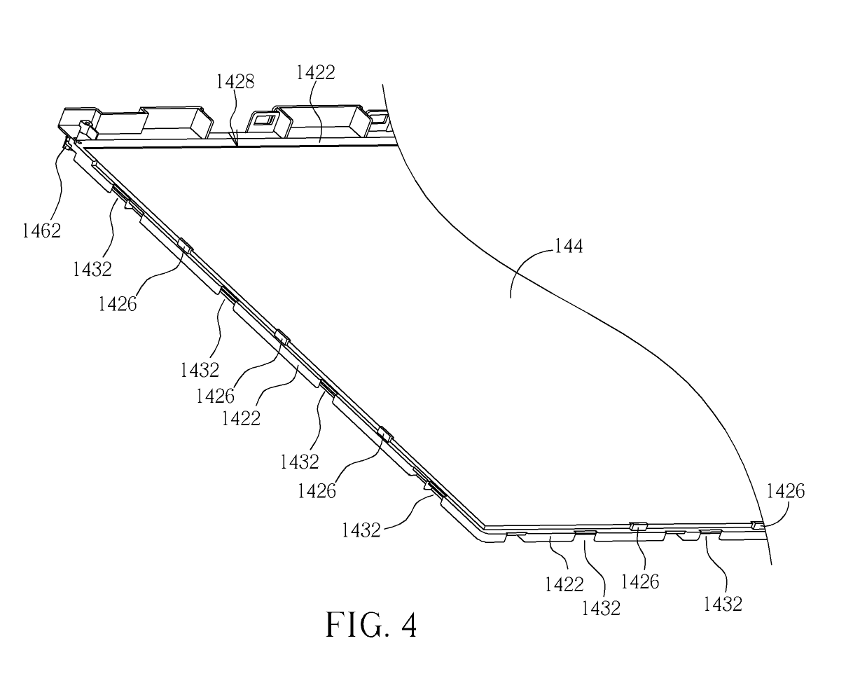

Please refer to FIG. 3. FIG. 3 is a partial exploded diagram of the optical touch module 14 in FIG. 2. The view of FIG. 3 is the view of the optical touch module 14 in FIG. 2 after turned around 180 degrees. The optical touch module 14 includes a second frame 142, a transparent plate 144, and an optical sensing module 146. The second frame 142 includes a plurality of rims 1422 connected to form a hollow portion 1424; therein, three of the rims 1422 forms a plurality of hooks 1426, and the other rim 1422 forms a stop wall 1428. A side of the transparent plate 144 is urged against the stop wall 1428. The other three sides of the transparent plate 144 are held by the hooks 1426, by which the transparent plate 144 is fixed on the second frame 142 to cover the hollow portion 1424, as shown in FIG. 4; therein, the view of FIG. 4 is substantially kept to be that of FIG. 3. In practice, the circumference of the transparent plate 144 can all be held by hooks, or the transparent plate 144 adheres to the second frame 142 through adhesive or double-sided tape disposed between the transparent plate 144 and the rims 1422 of the second frame 142, even together with a hook structure.

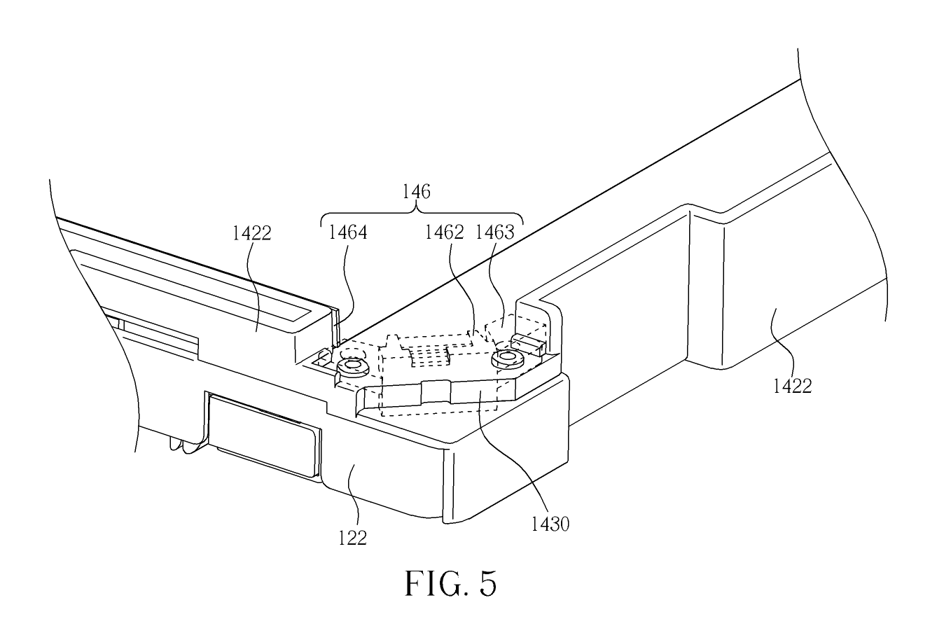

Further, the transparent plate 144 provides not only a protection function for the display panel 124 after the display module 12 and the optical touch module 14 are engaged, but also a structure for supporting the pressing by a user. Therefore, in practice, the transparent plate 144 has a touch indication area 1442 (shown in dashed lines) defined on a side surface of the transparent plate 144, which is substantially equal to the displaying area of the display panel 124. In other words, after the display module 12 and the optical touch module 14 are engaged, the transparent plate 144 covers the display panel 124 for protection, and the touch indication area 1442 is opposite to the hollow portion 1424. In this embodiment, the transparent plate 144 is made of tempered glass; however, the invention is not limited to this. The optical sensing module 146 includes two optical sensors 1462, two light sources 1463 such as LEDs, and a plurality of reflective sheets 1464, disposed on the second frame 142 and surrounding the touch indication area 1442. The two light sources 1463 are disposed beside the two optical sensors 1462 respectively for emitting light toward the touch indication area 1442. The reflective sheets 1464 reflect the light. The second frame 142 includes two fixing structures 1430 at two adjacent corners relatively to the touch indication area 1442. The optical sensors 1462 are fixed on the fixing structures 1430, as shown in FIG. 5; therein, the drawing scope and view of FIG. 5 is shown as the circle A in FIG. 2, and the optical sensor 1462 and the light source 1463 are shown in dashed lines. The optical sensors 1462 are used for judging a touch operation on the touch indication area 1442 by sensing the light reflected by the reflective sheets 1464.

Please refer to FIG. 1 and FIG. 2. In this embodiment, the first frame 122 includes a plurality of first lock engagement parts 1222, while the second frame 142 includes a plurality of second lock engagement parts 1432 for being engaged with the first lock engagement parts 1222 correspondingly. Therein, the first lock engagement part 1222 is a hook, and the second lock engagement part 1432 is a slot correspondingly. In a practical design of product, the first lock engagement part can be a hook or slot, and the second lock engagement part is a slot or a hook correspondingly. By use of the detachable engagement, the post maintenance is realizable and more efficient. The same engagement mechanism is used in the engagement of the first frame 122 and the back plate 126; therein, the sidewalls 1262 of the back plate 126 protrude to form a plurality of hooks 1264, and the first frame 122 forms a plurality of holes 1224 for being engaged with the hooks 1264 correspondingly. It is added that using the lock engagement structure has functions of not only holding and detaching with less damage but also positioning itself, which is not achieved just by any adhesive.

Compared with the prior art, the invention is to form the optical touch module to be structural modularized so that the optical touch module can be independent of the display module in structure, the assembly between the optical touch module and the display module is easier, and the stability in the assembly and the reliability of the assembled product are good, which efficiently solves the problems of the instability in production and the poor reliability of product due to the assembly in the prior art that the transparent protection plate and other related components of the optical sensing module adhere directly to the LCD display module just by adhesive. Furthermore, the invention is to make it possible that the optical touch module and the display module engaged with the optical touch module can be detached easily with less damage for maintenance on request of a post-repair, which greatly improves the service life of product and further also solves the potential problems in the production using adhesive in the prior art, such as structural loosing due to an aging of the adhesive, damage involved in the detachment of components by use of heating or chemical solution, a poor quality of a repaired or reworked product, and so on.

Those skilled in the art will readily observe that numerous modifications and alterations of the device and method may be made while retaining the teachings of the invention.

What is claimed is:

1. An optical touch module, for being engaged with a display module comprising a first frame and a display panel, the optical touch module comprising:
a second frame, for being engaged with the first frame, the second frame comprising a plurality of rims connected to form a hollow portion;
a transparent plate, fixed on the second frame to cover the hollow portion, the transparent plate having a touch indication area opposite to the hollow portion; and
an optical sensing module, disposed on the second frame, for sensing a touch operation on the touch indication area;
wherein, when the second frame is engaged with the first frame, the transparent plate covers the display panel.

2. The optical touch module of claim 1, wherein the second frame comprises a plurality of hook on at least one of the rims for fixing the transparent plate.

3. The optical touch module of claim 1, wherein the transparent plate adheres to the second frame by glue.

4. The optical touch module of claim 1, wherein the second frame comprises a stop wall, and a side of the transparent plate is urged against the stop wall.

5. The optical touch module of claim 1, wherein the first frame comprises a plurality of first lock engagement parts, and the second frame comprises a plurality of second lock engagement parts for being engaged with the first lock engagement parts correspondingly.

6. The optical touch module of claim 5, wherein the first lock engagement part is a hook or a slot, and the second lock engagement part is a slot or a hook correspondingly.

7. The optical touch module of claim 1, wherein the optical sensing module comprises two optical sensors, two light sources, and a plurality of reflective sheets disposed on the second frame and surrounding the touch indication area, the two light sources are disposed beside the two optical sensors respectively for emitting light toward the touch indication area, and the reflective sheets reflect the light.

8. The optical touch module of claim 7, wherein the second frame comprises two fixing structures, and the two optical sensors are fixed on the two fixing structures.

9. The optical touch module of claim 1, wherein the transparent plate is made of tempered glass.

10. An optical touch display module, comprising:
a display module, comprising:
a first frame; and
a display panel, disposed on the first frame; and
an optical touch module, comprising:
a second frame, engaged with the first frame, the second frame comprising a plurality of rims connected to form a hollow portion;
a transparent plate, fixed on the second frame to cover the hollow portion and the display panel, the transparent plate having a touch indication area opposite to the hollow portion; and
an optical sensing module, disposed on the second frame, for sensing a touch operation on the touch indication area.

11. The optical touch display module of claim 10, wherein the second frame comprises a plurality of hook on at least one of the rims to fix the transparent plate.

12. The optical touch display module of claim 10, wherein the transparent plate adheres to the second frame by glue.

13. The optical touch display module of claim 10, wherein the second frame comprises a stop wall, and a side of the transparent plate is urged against the stop wall.

14. The optical touch display module of claim 10, wherein the first frame comprises a plurality of first lock engagement parts, and the second frame comprises a plurality of second lock engagement parts for being engaged with the first lock engagement parts correspondingly.

15. The optical touch display module of claim 14, wherein the first lock engagement part is a hook or a slot, and the second lock engagement part is a slot or a hook correspondingly.

16. The optical touch display module of claim 10, wherein the optical sensing module comprises two optical sensors, two light sources, and a plurality of reflective sheets disposed on the second frame and surrounding the touch indication area, the two light sources are disposed beside the two optical sensors respectively for emitting light toward the touch indication area, and the reflective sheets reflect the light.

17. The optical touch display module of claim 16, wherein the second frame comprises two fixing structures, and the two optical sensors are fixed on the two fixing structures.

18. The optical touch display module of claim 10, wherein the transparent plate is made of tempered glass.

19. The optical touch display module of claim 10, wherein the display module comprises a back plate and a backlight module disposed on the back plate, and the back plate is engaged with the first frame to form an accommodating space for accommodating the display panel and the backlight module.
